(19) United States
(12) Patent Application Publication
(10) Pub. No.: US 2007/0260720 A1
(43) Pub. Date: Nov. 8, 2007

(54) Mobility domain

(76) Inventor: Gary Eugene Morain, San Jose, CA (US)

Correspondence Address: PERKINS COIE LLP, P.O. BOX 2168, MENLO PARK, CA, 94026, US

(21) Appl. No.: 11/417,830

(22) Filed: May 3, 2006

(51) Int. Cl. G06F 15/173

(52) U.S. Cl. 709/223

(57) ABSTRACT

A technique for buffering multicast messages in an access point (AP) relates to buffering multicast messages in an AP when a client of the AP is in powersave mode. Attributes of clients are used to group the clients into subsets, so multicast messages only need to be buffered if one of the clients in the subset in which an intended recipient is a member is in powersave mode. The buffered multicast message may then be sent at a later time when intended recipients are not in powersave mode.

### BACKGROUND

In many networks standards two broad categorizes of transmissions are defined, unicast and multicast. Unicast transmissions are often defined as transmissions bound for individual clients. Multicast transmissions are often defined as transmissions bound for a group of clients.

In many networks clients may operate in one of two modes: powersave and normal. In some cases, when a client is in powersave mode it no longer receives transmissions of data. There is a general need to buffer multicast packets when a client is in powersave mode.

For the example of the wireless standard 802.11, APs may be configured to buffer multicast messages when received and a client is in powersave mode. The AP will transmit all buffered multicast messages at a later time set by a delivery traffic indication message (DTIM). In IEEE 802.11 the receipt of a multicast packet is not acknowledged by a client so there is a need to buffer multicast packets for transmission when intended recipients are capable of receiving the message. DTIM sets when clients in powersave mode, if operating normally, enable their receivers for transmission of buffered multicast transmissions.

Buffering multicast data can cause performance problems. Often, when DTIM is reached buffered messages are sent in a rapid burst of multicast transmissions. The client may be unable to receive all the transmissions and drop part of the buffered multicast messages, because lost parts are not rebroadcast. In some instances the buffering of multicast messages may also cause problems such as increased latency and jitter.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for buffering multicast messages in an access point (AP). AP may, but not necessarily, include a processor, memory, one or more communication ports, and program modules and data structures. In some cases the AP will include a wireless communication port configured to use or capable of using the 802.11 standard. The AP may be coupled to a server and associated with clients. In some cases the AP includes a data structure storing the powersave mode of the clients, and the AP may also include a data structure storing other attributes of the clients.

The AP may receive multicast messages intended to be forwarded to clients. Instead of buffering messages when any client is in powersave mode the AP may use attributes of the clients to group the clients into subsets based on the similar attributes. The AP may then buffer multicast messages when a client in powersave mode is in the same subset as an intended recipient of the multicast data. The buffered data may then be sent at DTIM.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts an example of a system including clients which may be grouped into subsets.

FIG. 2A depicts an example of a system including an access point, a server and a plurality of clients grouped into subsets.

FIG.2B depicts an example of a system including an access point, a server and a plurality of clients, wherein the clients are grouped into subsets by their VLAN.

FIG. 2C depicts an example of a system including an access point, a server and a plurality of clients, wherein the clients are grouped into subsets by their SSID.

FIG. 2D depicts an example of a system including an access point, a server and a plurality of clients, wherein the clients are grouped into subsets by their encryption method.

FIG. 3 depicts an example of a system including an access point, a server, a switch, and a plurality of clients, wherein the switch can configure the AP.

FIG. 4 depicts an example of an access point for use in the system in FIG. 1, FIG. 2A, FIG. 2B, FIG. 2C, FIG. 2D, or FIG. 3.

FIG. 5A depicts a flowchart of an example of a method for buffering multicast messages.

FIG. 5B depicts a flowchart of an example of a method for buffering multicast messages using client VLAN attribute.

FIG. 6 depicts a flowchart of an example of a method for buffering multicast packets.

### DETAILED DESCRIPTION

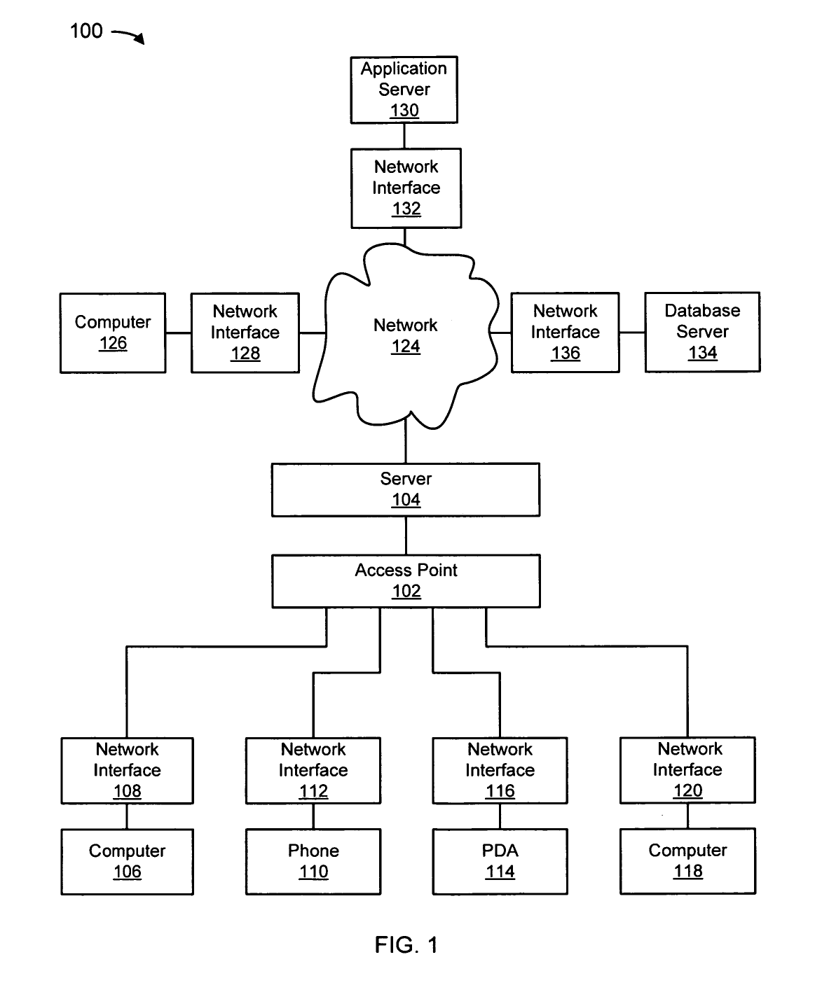

FIG. 1 depicts an example of a system 100 including clients which may be grouped into subsets. The example of FIG. 1 is intended to show a conceptual view of the system 100. The system 100 includes an access point (AP) 102 coupled to a server 104, a computer 106 coupled to a network interface 108, a phone 110 coupled to a network interface 112, a personal data assistant (PDA) 114 coupled to a network interface 116, and a computer 118 coupled to a network interface 120. The network interfaces 108, 112, 116, and 120 are coupled to a network 124. A computer 126 is coupled to a network interface 128, an application server 130 is coupled to a network interface 132, and a database server 134 is coupled to a network interface 136. The network interfaces 128, 132, and 136 are also coupled to the network 124.

In the example of FIG. 1, the AP 102 is configured to transmit data received from the server 104 to the network interfaces 108, 112, 116 and 120. The AP 102 is further able to buffer multicast data received from the server 104. The data received by the AP 102 from the server 104 does not necessarily originate from the server 104 and may originate from any source capable of transmitting to the server 104.

Multicast data is data transmitted to multiple intended recipients. Multicast techniques include replicating the data only when required, thereby reducing redundant transmissions. An example of an implementation of multicast, not meant as a limitation, is IP multicast, which is a protocol for transmitting to multiple clients on a TCP/IP networks. Using IP multicast packets allows a sender to transmit a message to multiple intended recipients in a manner that is known to someone familiar with the art.

In the example of FIG. 1, the AP 102 is coupled to the server 104 through any means known or convenient including a wireless connection utilizing two wireless radios, an infrared communication device, a dedicated wired connection, a wired local area network, a proprietary interface, etc. The AP 102 communicates with the network interfaces 108, 112, 116, and 120 through any known or convenient way, such as using packets, and communication may include wireless or wired transmissions, or a combination of wired and wireless transmissions, or any communication means known or convenient.

In certain embodiments the communication between an AP and clients can be achieved through, by way of example but not limitation, the use of a wireless radio using the IEEE 802.11 standards.

In a possible embodiment, an AP transmits data to a network interface divided into a plurality of data packets including a portion of the total data along with header data. In some embodiments the data packets will then be reassembled using header data. In certain embodiments the reassembly takes place by the network interface but in other embodiments a device other then a network interface may reassemble the packets. This may be accomplished in any way known or convenient. In other possible embodiments an AP is able to set the time clients in powersave mode exit powersave mode to receive buffered messages using DTIM.

In the example of FIG. 1, the sever 104 is coupled to the AP 102 as described above. In the example FIG. 1, the server 104 appears to be configured using one server computer, but this is an example not meant as a limitation. The server 104 may be implemented any way known or convenient as would be appreciated by one familiar with the art. The server 104 can communicate with a network 124 and transmit data received from the network 124 to the AP 102.

An example implementation of the server 104, not meant as a limitation, is the use of a RADIUS server. In another example embodiment a server comprises multiple devices operating in parallel or a distributed computing model as understood by someone familiar in the art. In another example embodiment a server and an AP are included physically or logically on one computer or electronic system. If in an example embodiment an AP is only a logical representation, the AP and the server would reside on the same device capable functioning as the AP and the server.

In the example of FIG. 1, the computer 106 may include various hardware and/or software components and various combinations of components. Any known or convenient computer system can be used and examples not meant as limitations are a desktop computer or notebook computer. The computer 106 is coupled to the network interface 108 through any way known or convenient. The network interface 108 is capable of communicating with the AP 102 in any known or convenient way. In some example embodiments the computer is able to send or receive multicast messages.

Examples of possible implementations of couplings not meant as limitations are a network interface built into a computer motherboard or as a network interface connected to an expansion slot on the computers motherboard.

In the example of FIG. 1, the network interface 108 can communicate with AP 102. Communication between the network interface 108 and the AP 102 can be done by any method known or convenient such as, by way of example but not limitation, through a wireless radio, through a wired modem, through a network, etc. An example embodiment of a network interface is a wireless radio configured to use an IEEE 802.11 wireless standard.

Examples of possible wireless standards included as way of example but not as a limitation are 802.11 and 802.16. All the above standards are based on standards developed by the IEEE.:
802.11—applies to wireless LANs and provides 1 or 2 Mbps transmission in the 2.4 GHz band using either frequency hopping spread spectrum (“FHSS”) or direct sequence spread spectrum (“DSSS”).
802.11a—an extension to 802.11 that applies to wireless LANs and provides up to 54 Mbps in the 5 GHz band. 802.11a uses orthogonal frequency division multiplexing encoding.
802.11b (also referred to as Wi-Fi)—an extension to 802.11 that applies to wireless LANS and provides 11 Mbps transmission (with a fallback to 5.5, 2 and 1 Mbps) in the 2.4 GHz band. 802.11b uses only DSSS.
802.11g—applies to wireless LANs and provides 20+ Mbps in the 2.4 GHz band.
802.16 (also referred to as WiMAX)—applies to wireless LANs and provides for transmissions in the 10 to 66 GHz bands and supports continuously varying traffic levels at many licensed frequencies for two-way communications. The draft amendment for the 2 to 11 GHz region will support both unlicensed and licensed bands.

As used here, the wireless 802.11 standard may include one or more extensions, not limited to those described above by way of example but not limitation. The preceding list is given as an example only and is in no way meant to be exhaustive on possible wireless standards possible to use. It would be impractical to list every possible wireless standard that could be used in conjunction with the techniques described herein. Any of the preceding communication standards may be used in any previous or subsequent discussion of wireless transmissions of data.

In the example of FIG. 1, the phone 110 is any known or convenient implementation which allows the transmission of sound. Examples of phones not meant as a limitations include a standard phone, a phone designed for communication over a network, or a microphone and speaker combination on a computer. Some phones may include video components, and some phones are capable of converting analog to digital. In some embodiments the phone is able to send and/or receive multicast messages.

In the example of FIG. 1, the network interface 112 is coupled to the phone 110 in any way known or convenient. Examples of couplings not meant as limitations include a phone and network interface included as one physical device or plugging a phone into a network interface.

In the example of FIG. 1, the network interface 112 can communicate with AP 102. Communication between the network interface 112 and the AP 102 can be done by any method known or convenient and examples not meant as limitation include through a wireless radio, through a wired modem, or through a network.

In the example of FIG. 1, the PDA 114 is any known or convenient implementation. Examples of a PDA include by way of example but not limitation a Black Berry, a PocketPC, or a Palm Pilot.

In the example of FIG. 1, the network interface 114 is coupled to the PDA 114 in any manner known or convenient. Examples of couplings not meant as limitations include a network interface and a PDA as components in one physical device, a network interface connected through an expansion slot on a PDA, or through another communication means such as blue tooth or infrared. In some embodiments the PDA is able to receive and/or send multicast messages.

In the example of FIG. 1, the network interface 114 can communicate with AP 102. Communication between the network interface 114 and the AP 102 can be done by any method known or convenient and examples not meant as limitation includes through a wireless radio, through a wired modem, or through a network.

In the example of FIG. 1, the computer 118 and the network interface 120 are similar to those described in reference to computer 106 and network interface 108.

In the example of FIG. 1, the network 124 can be any implementation of a network known or convenient. The network 124 is able to transmit data received from the network interfaces 128, 132, and 136 to the server 104. Some possible examples of networks not meant as limitations include a LAN, an intranet, the internet, or a combinations of different networks.

In the example of FIG. 1, the computer 126 may include various hardware and/or software components and various combinations of components. Any known or convenient computer system can be used and examples not meant as limitations are a desktop computer or notebook computer. The computer 126 is coupled to the network interface 128 through any way known or convenient. Examples of possible couplings not meant as limitations are a network interface built into a computer motherboard or as a network interface connected to an expansion slot on the computers motherboard. In some embodiments a computer is able to send a multicast message to multiple recipients.

In the example of FIG. 1, the application server 130 may include various hardware and/or software components and various combinations of components. The application server 130 is configured to run a software application or a plurality of software applications and provide use of the applications to others. Any known or convenient implementation of an application server can be used. In certain embodiments an application server is able to transmit multicast data.

In the example of FIG. 1, the network interface 132 is coupled to the application server 130 through any way known or convenient. Examples of possible couplings not meant as limitations are a network interface built into an application server motherboard, a network interface connected to an expansion slot on an application server, or any way known or convenient. In some embodiments an application server is able to send a multicast message.

In the example of FIG. 1, the database server 134 may be implemented by various hardware and/or software components and various combinations of components. The database server 134 is configured to run database management software and provide data contained within the database to others. Any known or convenient implementation of a database server can be used. In some embodiments the database sever is capable of transmitting multicast messages.

In the example of FIG. 1, the network interface 136 is coupled to the database server 134 through any way known or convenient. Examples of possible couplings not meant as limitations are a network interface built into a database server motherboard, as a network interface connected to an expansion slot on a database server, or any known or convenient manner. In some embodiments a database server is able to send a multicast message.

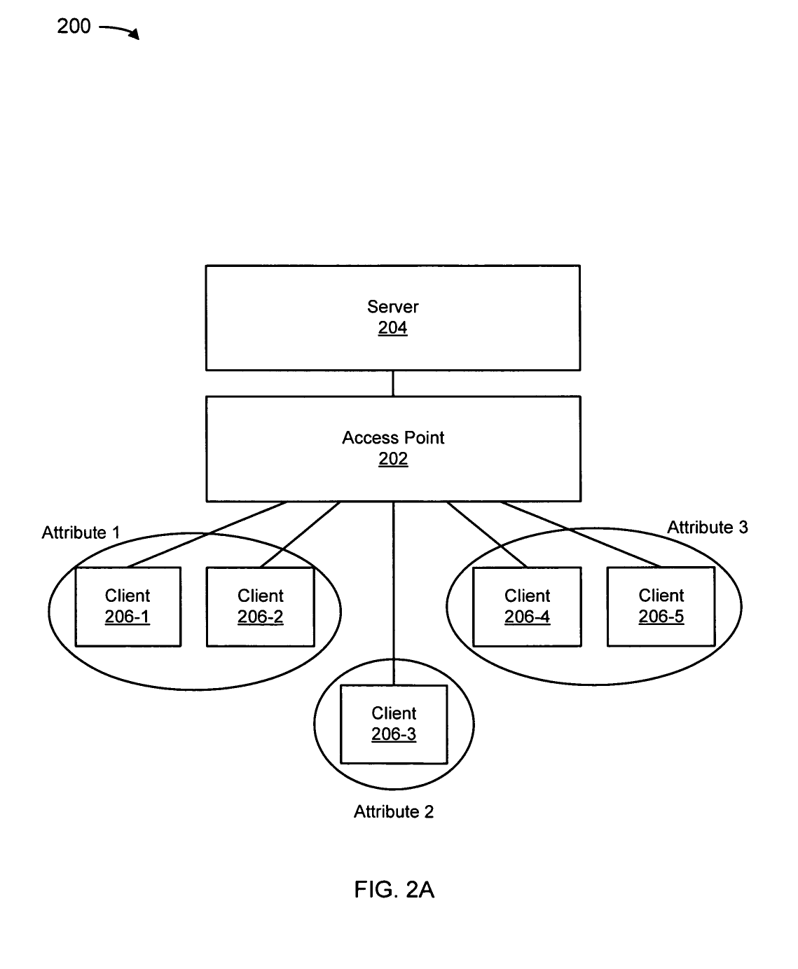

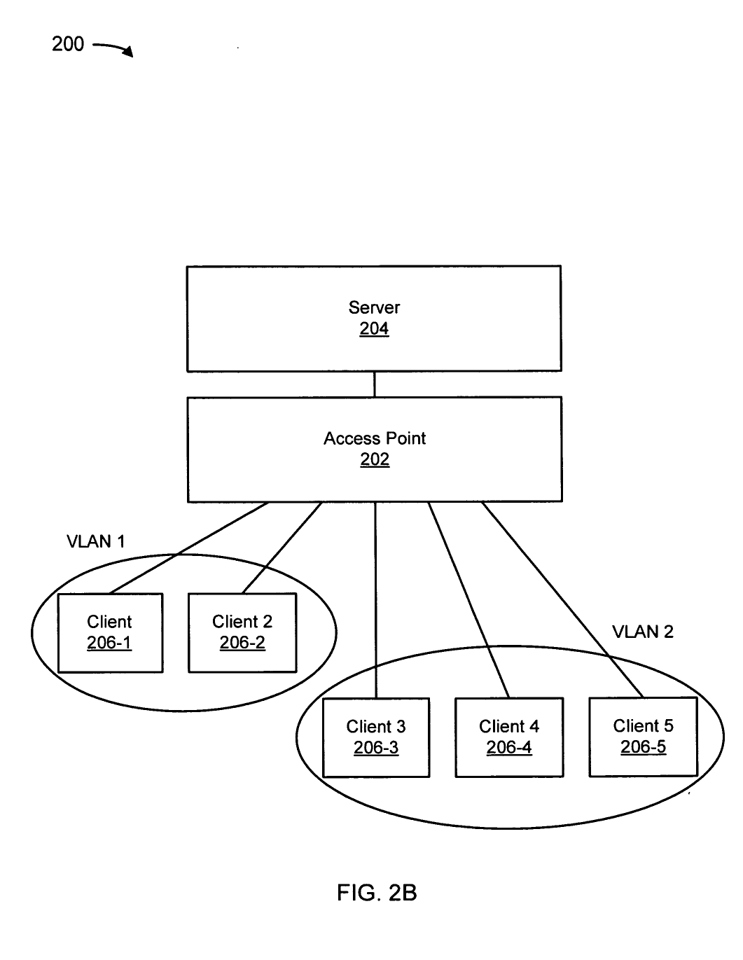

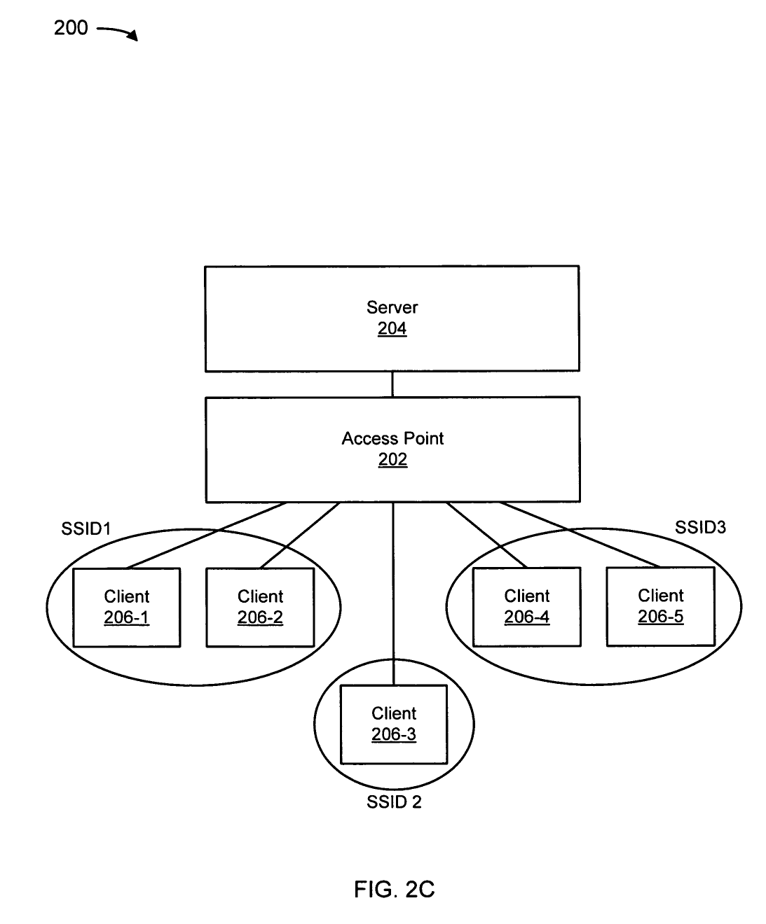

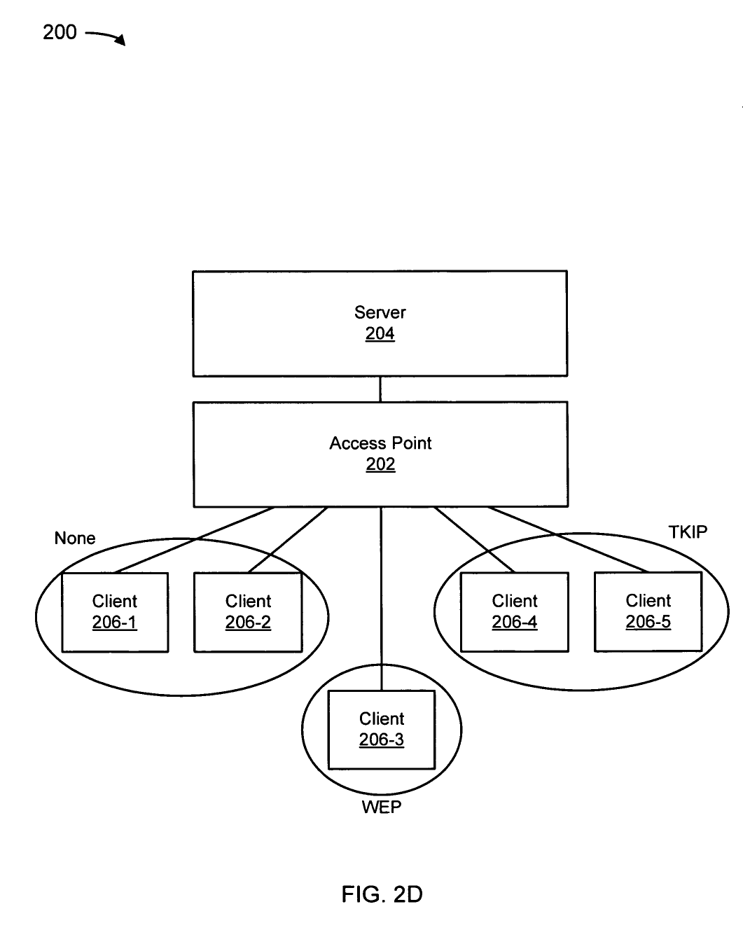

FIG. 2A depicts an example of a system 200 including an access point (AP), a server and a plurality of clients grouped into subsets. In the example of FIG. 2A, the system 200 is graphically depicted including an AP 202 coupled to a server 204, and clients 206-1, 206-2, 206-3, 206-4, and 206-5 (collectively referred to as clients 206). The server 204 may be configured similarly to the server 104 (FIG. 1).

In the example FIG. 2A, in operation, the AP 202 receives a multicast message to be transmitted to one or more of the clients 206. The multicast message can come from any source including the server 204, the clients 206, or some other source. In an embodiment, the AP 202 can buffer multicast messages. In an embodiment, the AP 202 uses attributes of the associated clients to create subsets of clients (Attribute 1, Attribute 2, Attribute 3). One or more of the clients 206 may be capable of entering a powersave mode. The multicast message is buffered for clients in the subset in which a member is in powersave mode but the multicast message is delivered to any subset without a member in powersave mode.

In the example of FIG. 2A, the AP 202 can communicate with a clients 206. Clients 206 are any device capable of communicating with AP 202. Examples of possible clients, as way of example and not as a limitation, include desktop computers, notebook computers, PDAs, phones, barcode scanners, dedicated hardware systems, proprietary hardware systems, etc. Other examples of possible clients are described in reference to the computer 106, the phone 110, the PDA 114, and the computer 118 above (FIG. 1).

In an embodiment, an AP may be associated with zero, one, or a plurality of clients. In a further embodiment the number of clients associated with an AP changes dynamically as clients connect and disconnect from the AP, thereby making the clients associate and disassociated with the AP.

FIG. 2B depicts an example of a system 200 including an AP 202, a server 204 and a plurality of clients 206-1, 206-2, 206-3, 206-4, 206-5 (collectively referred to as clients 206), wherein the clients are grouped into subsets by their virtual local area network (VLAN). In the example FIG. 2B, the system 200 graphically depicts the use of the VLAN of the clients 206 to create subsets of clients (VLAN 1 and VLAN 2). In the example FIG. 2B, the associated clients 206 are divided into two subsets based which VLAN a particular clients is a member.

An example of a VLAN is a logically independent network which does not depend on the physical layout of a network. An example VLAN configuration consists of a network of computers that behave as if physically contained on the same LAN. Network administrators configure VLANs through software rather than hardware, which in some cases makes them extremely flexible. In an embodiment, a user connected to a VLAN could move to another location, but remain on the same VLAN without the need for hardware reconfiguration. An example of a standard implementing VLANs but not meant to be a limitation is IEEE 802.1Q.

In the example in FIG. 2B, the clients 206 associated with the AP 202 belong to two separate VLANS, VLAN 1 and VLAN 2. The clients 206-1 and 206-2 are members of the VLAN 1, while the clients 206-3, 206-4, and 206-5 are members of the VLAN 2.

In some embodiments, a particular VLAN may have more members than those connected to an AP because the VLAN may not depend on physical implementation. In other embodiments all members of a VLAN are associated with an AP.

In an example embodiment a client or a plurality of clients are able to enter powersave mode. An AP is dynamically able to detect when an associated client enters powersave mode or is dynamically notified by the client when the client enters powersave mode. The AP may be configured to buffer multicast data received and to be transmitted to a client in powersave mode which is a member of the VLAN which the multicast data is to be sent.

FIG. 2C depicts an example of a system 200 including an access point, a server and a plurality of clients, wherein the clients are grouped into subsets by their service set identifier (SSID). In the example FIG. 2C, a system 200 graphically depicts the use of the SSIDs of the clients to create a subset of clients. In the example FIG. 2C, the associated clients 206 are divided into three subsets based on SSID.

In a non-limiting embodiment, an SSID is an identifier for members of a wireless network. In a non-limiting embodiment, the SSID is required in transmissions for the client to access the network. In some implementations, if a client is unable to provide the correct SSID the client will be unable to join the wireless network.

In the example of FIG. 2C, the clients 206 associated with the AP 202 have three separate SSIDs, SSID 1, SSID 2, and SSID 3. For illustrative purposes only, the clients 206-1 and 206-2 are members of SSID 1, the client 206-3 is a member of SSID 2, and the clients 206-4 and 206-5 are members of the SSID 3.

In some embodiment a particular SSID may have more members then those connected to an AP. In other embodiments all clients with a particular SSID are associated with an AP.

In one example embodiment a client or a plurality of clients are able to enter powersave mode. An AP is dynamically able to detect when an associated client enters powersave mode or is dynamically notified by the client when the client enters powersave mode. The AP is configured to buffer multicast data received and to be transmitted to a SSID that includes a client in powersave mode.

FIG. 2D depicts an example of a system 200 including an access point, a server and a plurality of clients, wherein the clients are grouped into subsets by their encryption method. The example of FIG. 2D is intended to graphically depict clients divided into subsets based on an associated encryption method. In the example of FIG. 2D, not using encryption is treated as an “encryption method.”

Encryption is the modifying of information into a secure format. In some example encryption methods a key is required to decrypt the information. Many different types of encryption methods may be used to communicate between a server and clients and the client's encryption method may be used to divide clients into subsets. Some example encryption methods are WEP, WPA, TKIP, etc.

In the example of FIG. 2D, the clients 206-1 and 206-2 are grouped into a subset for no encryption, the clients 206-3 and 206-3 are grouped in a subset for WEP encryption method, and the client 206-5 is in a subset for the TKIP encryption method. In short, the encryption method can be used to group the clients into subsets.

There are numerous encryption methods and any encryption method known or convenient may be used to create subsets of clients. Example encryption methods not meant as limitations include codes, ciphers, a combination of code and cipher, symmetric key algorithms, and asymmetric key algorithms.

In one example embodiment a client or a plurality of clients are able to enter powersave mode. An AP is dynamically able to detect when an associated client enters powersave mode or is dynamically notified by the client when the client enters powersave mode. The AP is configured to buffer multicast data received and to be transmitted to a subset in which those using a particular encryption method in which a client in powersave mode.

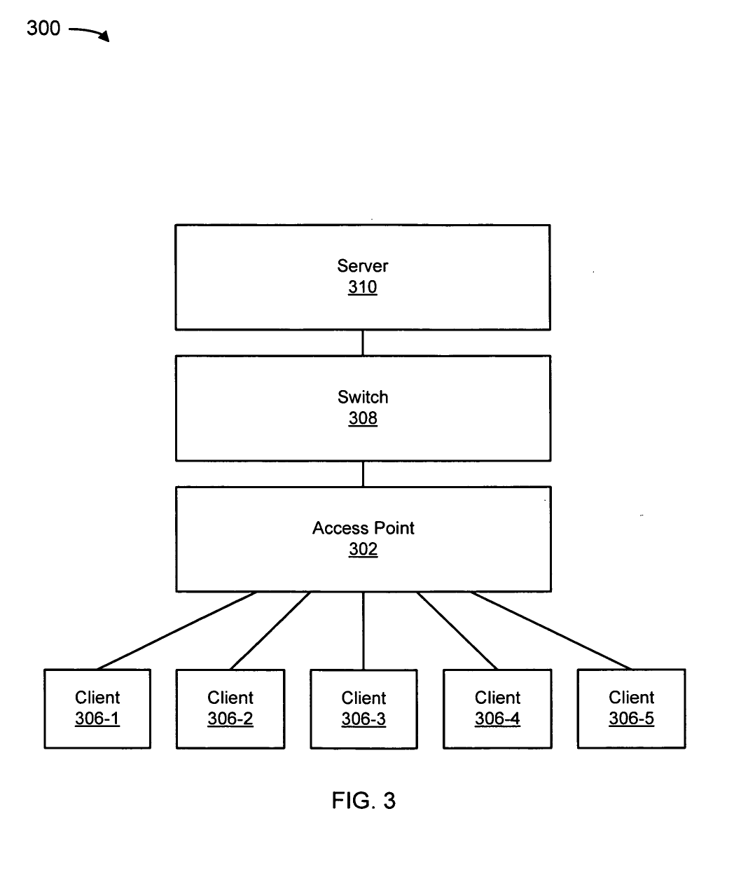

FIG. 3 depicts an example of a system 300 including an access point, a server, a switch, and a plurality of clients, wherein the switch can configure the AP. In the example of FIG. 3 a possible embodiment of the invention is shown including an access point (AP) 302, a server 310 coupled to a switch 308, and clients 306-1, 306-2, 306-3, 306-4, 306-5 (collectively referred to as clients 306)

The AP 302 is similar to the AP described above in reference to AP 102 (FIG. 1). The clients 306 are similar to those described above in reference to Clients 206 (FIG. 2A). The server 310 and switch 308 are coupled which may be accomplished in any wired or wireless means known and convenient.

In some embodiments, a server is connected to a plurality of APs, devices and/or networks. In further possible embodiments a server and a switch are included on the same physical device and any division is logical in nature only.

In an example embodiment a server could be a remote authentication dial in user service (“RADIUS”) server. In an example embodiment a switch could be a Mobility Exchange (“MX”) switch. In certain embodiments the switch may be connected to a plurality of RADIUS or other servers and/or a plurality of APs.

In some embodiments the switch 308 is capable of some level of control and/or configuration of an AP. In other embodiments the switch 308 is connected to multiple APs and can track the movement of clients from one AP to another.

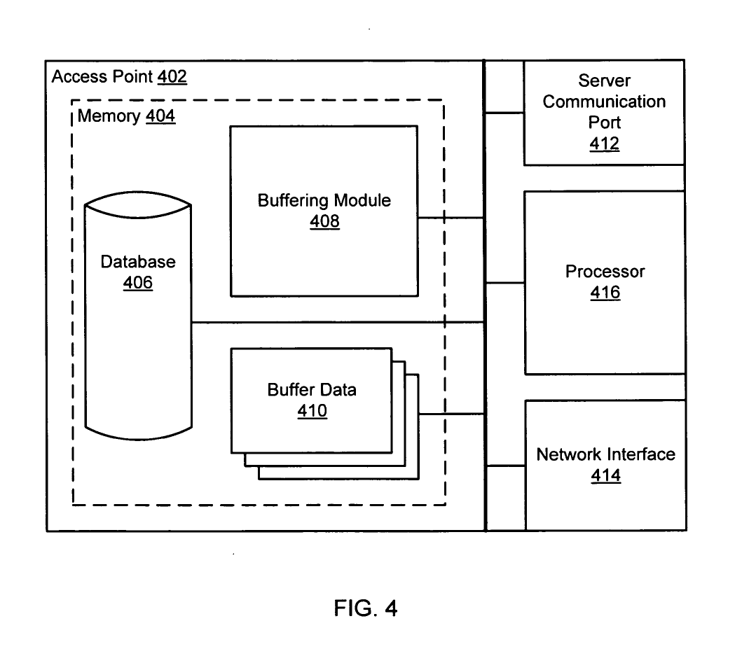

FIG. 4 depicts an example of an access point for use in a system such as that described by way of example but not limitation with reference to FIGS. 1-3. FIG. 4 is an example embodiment of an access point 402 and includes memory 404, a server communication port 412, a network interface 414, and a processor 418. The memory 404 includes a database 406, a buffering module 408, and buffer data 410.

In the example of FIG. 4, the memory 404 can be any known or convenient type of memory which is capable of holding a database, program modules, and data. The memory 404 is coupled to the processor 418 capable of accessing the database 406, the buffering module 408 and other data contained in the memory 404. Examples of types of memory include cache, main memory and secondary storage or a combination thereof. In an alternative non-limiting embodiment, one or more of the database 406, the buffering module 408, and the buffer data 410 may be stored in firmware or hardware.

In certain embodiments a database, buffering module, buffer data or other data stored in a memory may be stored in a combination of memory types such as main memory and secondary storage. The structure of the stored data will be specific to the implementation and the state of an AP.

In the example FIG. 4, the database 406 stores powersave attributes for a plurality of clients associated with the AP 402. The database 406 may be implemented in any way known or convenient, and some examples of databases not meant as limitations include relational, file based, or object oriented.

In certain embodiments a database is further configured to store one or more attributes of clients associated with the AP 402 in addition to the powersave attributes. Some example attributes a database may be configured to store include by way of example but not limitation a VLAN attribute, a SSID attribute, or an encryption method attribute.

In some embodiments a database is updated with the powersave modes of clients associated with an AP. The associated clients may automatically broadcast their powersave state to the AP, notifying the AP if entering powersave mode or leaving powersave mode. In certain embodiments, after these broadcast transmissions are received by an AP the information is updated in the database. Alternatively, the clients can unicast or multicast their powersave state to, for example, a particular AP, server, or some other location.

In the example of FIG. 4, the buffering module 408 is configured to use the powersave attributes of clients stored in the database 406 to determine whether to buffer received multicast messages. The buffering module 408 uses the attributes of associated clients stored in the database 406 to create a subset of clients to which the multicast message is to be transmitted. The buffering module 408 associates a multicast message with a subset of clients. In an embodiment, the buffering module 408 is configured to buffer the multicast message in the buffer data 410 when at least one client of the subset of the clients is in a powersave state.

In the example of FIG. 4, the buffering module 408 is capable of receiving multicast messages from the server communication port 412. The buffering module 408 is able to determine if there is a client in the subset, designated by the multicast packet, that is in a powersave state. The buffering module 408 maybe configured to associate clients into sets in any manner known or convenient. For example, clients may be divided into subsets using one or more of the following attributes of the clients, the VLAN to which the client belongs, the SSID of the client, the encryption method used by the client, etc.

In some embodiments a buffering module associates the multicast message with a subset of clients using one or more of the following attributes of the clients, a VLAN attributes, a SSID attributes or an encryption method attributes. If a multicast message is sent to the subset of clients and a member is in a powersave state the multicast message is buffered by the buffering module in a buffer data. In further embodiments when DTIM is reached a buffer data is read and any multicast messages are transmitted.

In some embodiments a multicast message is already associated with a subset when received by an AP and a buffering module uses the associations in determining when to buffer multicast messages.

In the example FIG. 4, the buffer data 410 is contained in memory 404 and stores multicast messages buffered by the buffering module 408. The buffer data 410 may be in any form known or convenient. An example implementation not meant as a limitation is a stack in the memory 404.

In other embodiments, associating a multicast message with a subset is done prior to the multicast message being received by an AP. In this embodiment a server may, for example, associate the multicast message with a client subset before sending the multicast message. The AP may determine if any member in the subset is in a powersave state. In another embodiment, the multicast data is associated with clients by both a server and an AP.

In certain embodiments, a buffering module is configured to determine which attributes are used to group the client set into subsets. The methodology used by the buffering module in determining attributes to create subsets may be user configurable, statically defined, or determined through logic in the AP.

In the example of FIG. 4, the AP 402 includes the server communication port 412, which is capable of communicating with a server. The server communication port 412 is able to communicate with the server in any method known or convenient. The communication port 412 may use any combination of communication technology such as wireless, wired, dedicated hardwiring, through a LAN, etc.

In the example of FIG. 4, the AP 402 includes a network interface 414 capable of communicating with a client or a plurality of clients. The network interface 412 is a communication port capable of communicating with the clients. Network interface 412 may use any combination of communication technology such as wireless, wired, dedicated hardwiring, etc.

In certain embodiments a network interface is a communication port capable of communicating with clients and is a wireless radio capable of two way communication with a client. In a further embodiment a network interface is a wireless radio and the wireless radio is configured to use an IEEE 802.11 wireless communication standard.

In certain embodiments a server communication port and a network interface are one physical communication port capable of communicating with both a plurality of clients and a server. In another embodiment a server communication port and a network interface are two separate communication ports.

In the example of FIG. 4, the processor 416 may be any known or convenient processor, including by way of example but not limitation, a general processor, a dedicated processor, or a combination of processors. The processor is coupled to the memory 404 and can access the database 406 and execute the buffering module 408 in the memory 404.

In certain embodiments an AP has multiple processors working in parallel. The processors can be on the same physical machine or distributed across multiple machines.

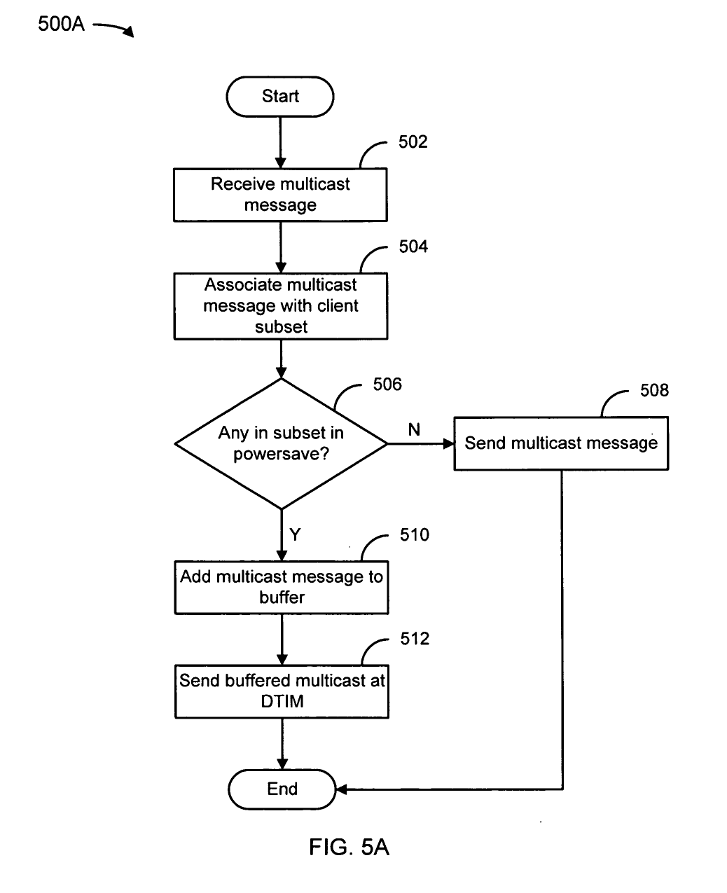

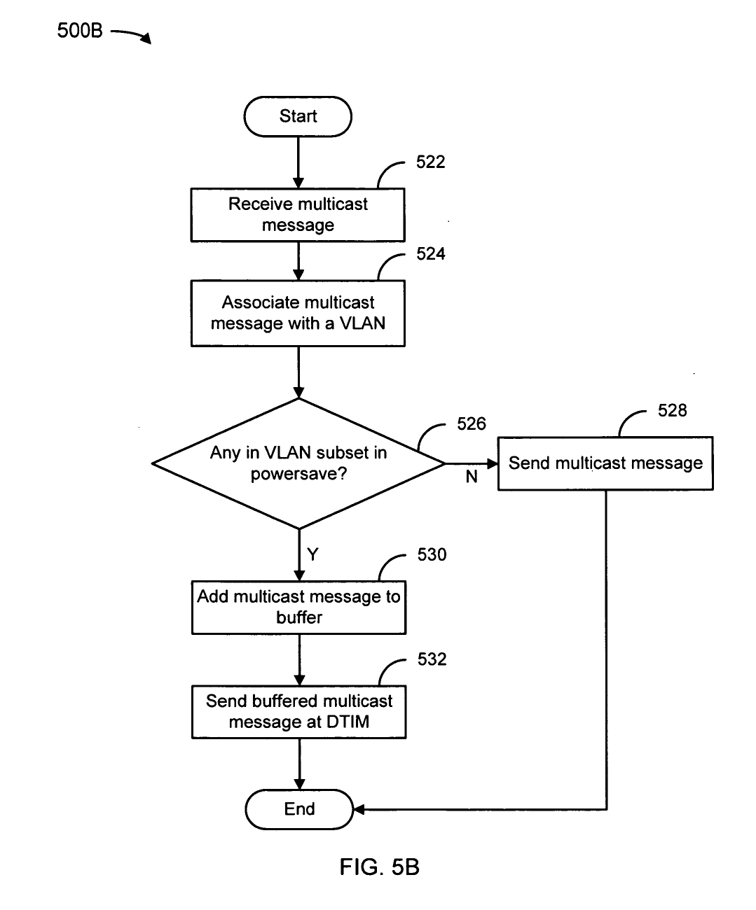

FIG. 5A depicts a flowchart 500A of an example of a method for buffering multicast messages. This method and other methods are depicted as serially arranged modules. However, modules of the methods may be reordered, or arranged for parallel execution as appropriate. FIG. SA is intended to illustrate a first example of operation of a system, such as that depicted in FIG. 2A, using techniques described herein. The flowchart 500A proceeds from the point from which a multicast message is received to the point that it is sent to intended clients. However, it should be noted that the method of FIG. 5A is not intended to be limited to the components depicted in FIG. 2A, and may be applicable to other systems and configurations.

In the example of FIG. 5A, in block 502 a multicast message is received. The multicast message may be received at, by way of example but not limitation, an AP or some other intermediary to a plurality of clients. The multicast message may be sent from, by way of example but not limitation, a server. The transmission of the multicast messages may be done in any way known or convenient.

In the example of FIG. 5A, in block 504 the multicast message is associated with a subset of clients. Depending on the composition of the clients, the subset of clients may be in some situations equal to the set of clients. The multicast message may originate from one of the clients, or from some other source.

In a non-limiting embodiment, a server associates the multicast message with a subset of clients before the multicast message is received by, for example, an AP. In this embodiment the AP determines whether any clients in the set are in a powersave state. In another embodiment, the, e.g., AP and the, e.g., server may both associate the multicast message with a set of the clients and the resulting set used being the intersection of two or more subsets.

In the example of FIG. 5A, at decision point 506 it is determined if one or more of the clients in the subset of clients are in a powersave state. For example, an AP may check whether the clients are in a powersave state and determine if any of these are included in a subset of clients.

In a possible embodiment, the, e.g., AP may update the powersave state of clients in real-time as described above with reference to FIGS. 2A to 2D. In some embodiments, not all clients are able to enter a powersave state. In some embodiments a client enters a powersave state automatically when certain conditions are met such as the client has not been used for a certain period of time or the client is almost out of battery life. In some embodiments a client may be manually asked to enter a powersave state.

In the example of FIG. 5A, if none of the clients in the subset are in a powersave state (506-N) then at block 508 the multicast message is sent to the clients associated with the subset.

In the example of FIG. 5A, if one or more of the clients in the subset are in a powersave state (506-Y), then at block 510 the multicast message is buffered. The buffered data may include multicast messages for multiple client subsets from multiple sources. Each multicast message may be associated with a different DTIM or alternatively all may use the same DTIM to determine when to send the buffered multicast message to the clients in the subset.

In the example of FIG. 5A, at block 512 the multicast message is buffered when an intended recipient is a member of a subset in which the intended recipient and/or another member of the subset is in a powersave state.

In another possible embodiment, multicast messages are buffered automatically regardless of the powersave state of members in the subset. In other possible embodiments the multicast messages are buffered in other forms besides a stack such as a queue, randomly, placed at earliest open spot, etc.

In the example of FIG. 5A, the buffered message is then sent when DTIM is reached. Clients in a powersave state enter a non-powersave state to receive buffered multicast messages.

In the example of FIG. 5A, the buffer is then purged of the sent multicast data. This is only one possible embodiment and the data could be retained in memory or some other location if convenient. A possible example not meant as a limitation would be to back-up the data for security or reasons.

FIG. 5B depicts a flowchart 500B of an example of a method for buffering multicast messages using client VLAN attributes. In the example of FIG. 5B, the flowchart 500B depicts a method that uses the VLAN associated with the client to determine which clients with which to associate the multicast message. FIG. 5B is intended to illustrate an example of operation of a system such as that depicted in FIGS. 2A and/or 2B, using the techniques described herein. The blocks and decision points of the flowchart 500B are similar to those of the flowchart 500A and are, therefore, not described at length.

In the example of FIG. 5B the flowchart 500B begins at block 522 where a multicast message is received. At block 524, the multicast message is associated with a VLAN. Each VLAN may include clients that may be referred to as a subset of all clients. It may be desirable to characterize the subset of clients as the clients associated with the VLAN that are connected to a network at an AP. If, at decision point 526, none of the clients of the VLAN that are connected to the network at the AP are in a powersave state, then the multicast message is sent at block 528. Otherwise, the multicast message is added to the buffer at block 530 and the buffered message is sent at DTIM at block 532.

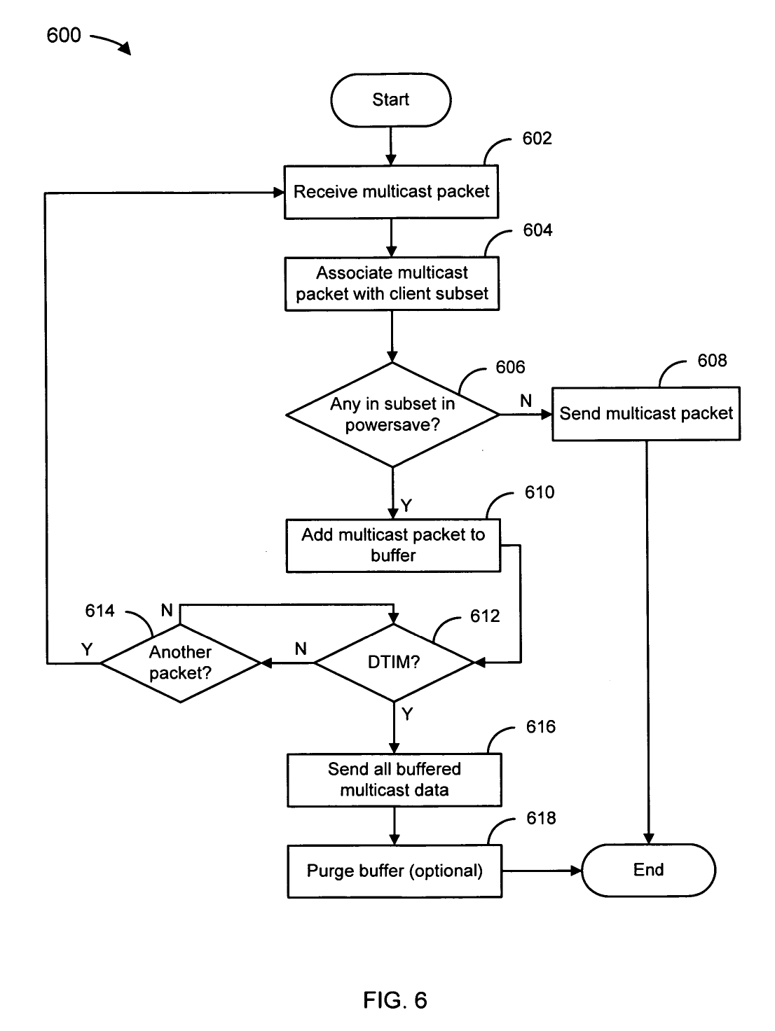

FIG. 6 depicts a flowchart 600 of an example of a method for buffering multicast packets. The example of FIG. 6 depicts a method for buffering multicast packets. FIG. 6 is intended to illustrate a second example method of operation of a system such as that depicted in FIGS. 2A-2D, using the techniques described herein.

In the example of FIG. 6, a flowchart 600 graphically depicts an example flow of information in a sample embodiment. The flowchart 600 starts at block 602 when a multicast packet is received. The multicast packet may be received by, by way of example but not limitation, an AP or other intermediary between the source and one or more of the intended recipients. The multicast packet will typically have header information including data that can be used to identify the packet as a multicast packet.

In some embodiments an AP may at times continuously or nearly continuously receive packets from different sources including but not limited to clients and a server. In certain embodiments an AP receives packets from sources originating from a LAN, internet, or intranet. In some examples an AP receives a mix of unicast and multicast packets.

In the example of FIG. 6, the flowchart 600 continues at block 604 where the multicast packet is associated with a subset of clients. The clients may be associated with the multicast packets at, by way of example but not limitation, an AP, a server, and/or some other location. Depending on the composition of the clients associated with, e.g., an AP the subset of clients may be equal to the set of clients.

In the example of FIG. 6, the flowchart 600 continues at decision point 606 where it is determined whether any of the clients connected to a network via, e.g., an AP, are in a powersave state. If none of the subset of clients associated with the multicast packet are in a powersave state (606-N), the multicast packet is transmitted to the client(s) at block 608 and the flowchart 600 ends. Otherwise (606-Y), the flowchart 600 continues at block 610 where the packet is added to a buffer.

In the example of FIG. 6, the flowchart 600 continues at decision point 612 where it is determined whether DTIM has been reached. If DTIM has not been reached (612-N), then the flowchart 600 continues at decision point 614 where it is determined whether another multicast packet has been received. If another multicast packet has been received (614-Y), then the flowchart 600 returns to block 602. If another multicast packet has not been received (614-N), then the flowchart 600 returns to decision point 612. These blocks and decision points are repeated until DTIM is reached (612-Y).

After DTIM is reached, the flowchart 600 continues at block 616 where all buffered multicast packets are sent to the intended recipients connected to the network via, e.g., the AP. The flowchart 600 continues at optional block 618 where the buffer is purged. Block 618 is optional because in some cases it may be desirable to retain the buffer to, for example, send again later if no acknowledgement is received. In many embodiments, no acknowledgement from the clients is required. In other possible embodiments, the buffered multicast data may be retained in part or in total in memory or some other location if convenient.

The term “powersave mode” has been used to mean the process of a client entering a state of reduced energy expenditure and includes turning off the client's communication port. The term “powersave state” has been used to mean a general term describing any state a client may be in which conserves energy. In the powersave state the client may or may not have disabled the client's communication port.

The term “data” has been used to mean any digital information. The term “transmission” has been used to indicate any flow of data from one device to another. The term “intended recipient” has been used to apply to a client which was intended to receive a transmission. The term “communication port” has been used to describe any device allowing communication of data with another device.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

I claim:

1. A system comprising:
a processor; memory coupled to the processor, wherein the memory stores program modules executable by the processor;
the memory including:
a database storing a powersave attribute for a plurality of clients, a buffering module capable of associating a multicast message with a subset of the clients, the buffering module further configured to buffer the multicast message when at least one client of the subset of the clients is in a powersave mode;
a communication port capable of communicating with the clients;
a communication port capable of communicating with a server.

2. A system as recited in claim 1, wherein the communication port capable of communicating with the clients and the communication port capable of communicating with the server are separate communication ports.

3. A system as recited in claim 1, wherein the communication port capable of communicating with the clients is a wireless radio.

4. A system as recited in claim 1, wherein the communication port capable of communicating with the clients is a wireless radio and the wireless radio is configured to use an IEEE 802.11 wireless communication standard.

5. A system as recited in claim 1, wherein the multicast message is buffered in the memory, wherein, in operation, at DTIM the memory is read and the multicast message is transmitted.

6. A system as recited in claim 1, wherein the buffering module associates the multicast message with the subset of the clients using one or more of the following attributes of the clients, a VLAN attribute, a SSID attribute, or an encryption method attribute.

7. A system as recited in claim 1, wherein the database is further configured to store one or more attributes of the clients, wherein the attributes are used in grouping the clients into subsets and the subsets are used to reduce the number of buffered multicast messages, wherein, in operation, network performance is increased by reducing dropped packets, latency, and jitter.

8. A system as recited in claim 1, wherein the database is further configured to store one or more of the following attributes of the associated clients, a VLAN attribute, a SSID attribute, or an encryption method attribute,

9. A system as recited in claim 1, wherein, in operation, the buffering module associates the multicast message with the subset of the clients using one or more attributes of the clients.

10. A system comprising:
a server comprising:
a server processor; server memory coupled to the server processor, wherein the server memory stores program modules executable by the server processor;
a server communication port capable of communicating with an access point (AP);
the AP comprising:
a AP processor; AP memory coupled to the AP processor, wherein the AP memory stores program modules executable by the AP processor;
the AP memory including:
a database storing powersave attributes for a plurality clients,
a buffering module capable of:
associating a multicast message with a subset of the clients,
buffering the multicast message when a member client of the subset of the clients is in powersave mode;
a communication port capable of communicating with the clients;
a communication port capable of communicating with a server;
the plurality of clients associated with the AP each comprising:
a client processor; client memory coupled to the client processor, wherein the client memory stores program modules executable by the client processor;
a client wireless communication port capable of communicating with the AP.

11. A system as recited in claim 10, wherein the client wireless communication port is a wireless radio.

12. A system as recited in claim 10, wherein the client wireless communication port is a wireless radio, wherein the wireless radio uses an IEEE 802.11 standard.

13. A system as recited in claim 10, wherein some of the associated clients are capable of entering powersave mode.

14. A system as recited in claim 10, wherein the server comprises a switch coupled to the server, wherein the switch is capable of controlling and configuring a plurality of APs.

15. A method comprising:
receiving a multicast message having a plurality of intended recipients;
determining if one or more of the intended receipts is in a powersave state;
transmitting the multicast message to the intended recipients if none of the intended recipients are in a powersave state;
if one or more of the intended recipients are in a powersave state:
buffering the multicast message;
transmitting the multicast message at DTIM.

16. A method as recited in claim 15, further comprising buffering the multicast message regardless of whether one or none of the intended recipients are in a powersave state.

17. A method as recited in claim 15, further comprising associating the multicast message with the intended recipients.

18. A method as recited in claim 15, wherein the multicast message is associated with the subset of the clients using one or more of the following attributes of the clients, a VLAN attribute, a SSID attribute, or an encryption method attribute.

19. A method as recited in claim 15, further comprising transmitting the multicast message when every intended recipient changes to a non-powersave state.

20. A method as recited in claim 15, wherein the multicast message is transmitted in packets containing header data and multicast data.
